(19) United States
(12) Patent Application Publication
(10) Pub. No.: US 2008/0169230 A1
(43) Pub. Date: Jul. 17, 2008

(54) Pumping and Dispensing System for Coating Semiconductor Wafers

(75) Inventor: Seiji Nakagawa, Oita-pref (JP)

Correspondence Address: BANNER & WITCOFF, LTD., 1100 13th STREET, N.W., SUITE 1200, WASHINGTON, DC, 20005-4051, US

(73) Assignee: TOSHIBA AMERICA ELECTRONIC COMPONENTS, INC., Irvine, CA (US)

(21) Appl. No.: 11/622,529

(22) Filed: Jan. 12, 2007

(51) Int. Cl. B01D 19/00

(52) U.S. Cl. 210/188

(57) ABSTRACT

A pumping/dispensing system is disclosed that is able to efficiently pump and dispense resist solution, anti-reflective coating (ARC) solution, or other solutions, with less bubbles, such as micro-bubbles, and/or less dissolved gas. The system has a pump that separates bubbles from the solution prior to dispensing the solution outside of the system. A circulation loop is provided in which the solution passes through a filter before being pumped. A pressure drop across the filter is sufficient to induce bubbles at the back end of the filter, and these bubbles are separated and removed by the pump before dispending. Accordingly, little or no further bubbles are formed at the pressure drop of the outlet when dispensing the solution.

### BACKGROUND

The manufacture of semiconductor devices involves creating a semiconductor wafer and performing various processing techniques on the wafer. One such technique includes performing lithography by exposing the wafer with a projected image that depends upon circuitry design to be embodied on the wafer. Before projecting the image, a resist coating and an anti-reflective coating (ARC) are applied to the surface of the wafer. To ensure that the projected image is properly exposed onto the wafer, it is important that the resist and ARC coatings be smooth and relatively free of bubbles or other contaminants.

Dispense systems have been devised that dispense an appropriate amount of resist and ARC onto wafers. There are two conventional types of such dispense systems: a single-stage system and a dual-stage system. Each of these systems are designed to reduce the contaminants that might otherwise be present in the dispensed chemicals. However, each of these systems have associated problems.

FIG. 1 is a functional block diagram of a conventional single-stage dispense system 100. System 100 includes a reservoir 102 that holds resist or anti-reflective coating (ARC) solution 102. A pump 104 draws solution 102 through a pipe 105 and expels solution 102 out through a pipe 106. Solution 102 then passes through a filter 103, which removes solid contaminants (indicated in FIG. 1 by black circles) from solution 102. After filtering, solution 102, still under pressure from pump 104, is passed through a pipe 107 to an outlet 108. Solution 102 then contacts and spreads over a semiconductor wafer 105, which may be on a platform 130 that is spinning, to further spread solution 102 over its surface.

There are various problems with this type of single-stage system 100. For example, over time, filter 103 becomes clogged, thereby reducing the maximum flow rate of solution 102 and affecting the amount of solution 102 that may be dispensed to a given wafer. This is undesirable as there is a low tolerance for dispense rate variability. Accordingly, filter 103 must be regularly cleaned or replaced to maintain an appropriate dispense rate. In addition, system 100 causes an undesirable amount of micro-bubbles 109 (indicated in FIG. 1 by white circles) to form in the dispensed solution 102, which can jeopardize the subsequent lithography step. Micro-bubbles 109 are formed from gas dissolved in solution 102 when there is a sudden drop in solution pressure, such as at outlet 108 where the pressurized solution 102 exits enclosed pressurized pipe 107 and quickly depressurizes to the ambient room pressure.

FIG. 2 is a functional block diagram of a conventional dual-stage dispense system 200. System 200 includes a reservoir 201 that holds resist or ARC solution 202. A first pump 204 (also referred to as the recirculation pump) draws solution 202 through a pipe 206 and expels solution 202 out through a pipe 207. Solution 202 then passes through a filter 203, which removes solid contaminants from solution 202. After filtering, solution 202, still under pressure from pump 204 either passes back into pump 204 through a recirculation loop 210 or is passed through a pipe 208 to a second pump 205 (also referred to as the dispense pump). Solution 202 is then pumped by pump 205 into pipe 209, and then expelled out of outlet 208. Solution 202 then contacts and spreads over a semiconductor wafer 205, which may be on a platform 230 that is spinning, to further spread solution 202 over its surface.

By using a separate recirculation pump 204, dispense system 200 reduces the dispense amount variability problem as compared with system 100. However, system 200 also causes an undesirable amount of micro-bubbles 209 to form at outlet 208. In addition, dual-stage systems such as system 200 are relatively expensive to build and operate. Such a system use two pumps instead of one, thus increasing the number of parts to build and maintain and increasing the amount of energy used to operate the system.

### SUMMARY

There is a need for an improved pumping/dispensing system that is able to efficiently pump and dispense resist and/or anti-reflective coating (ARC) materials with less micro-bubbles and/or dissolved gas.

According to an aspect of the present disclosure, a system is disclosed that has a pump that separates bubbles, such as micro-bubbles, from a solution prior to dispensing the solution outside of the system. Such a system may have a circulation loop in which the solution passes through a filter before passing through the pump. A pressure drop across the filter may be sufficient to induce bubbles at the back end of the filter. These bubbles may then be separated and removed by the pump by taking advantage of the natural buoyancy of the bubbles. By the time the solution exits the system through the dispensing outlet, much if not all of the dissolved gas has thus been removed from the solution. Accordingly, little or no further bubbles are formed at the pressure drop of the outlet when dispensing the solution.

These and other aspects of the disclosure will be apparent upon consideration of the following detailed description of illustrative embodiments.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a functional block diagram of a conventional single-stage pumping/dispensing system.

FIG. 2 is a functional block diagram of a conventional dual-stage pumping/dispensing system.

FIG. 3 is a functional block diagram of an illustrative pumping/dispensing system in accordance with aspects of the present disclosure.

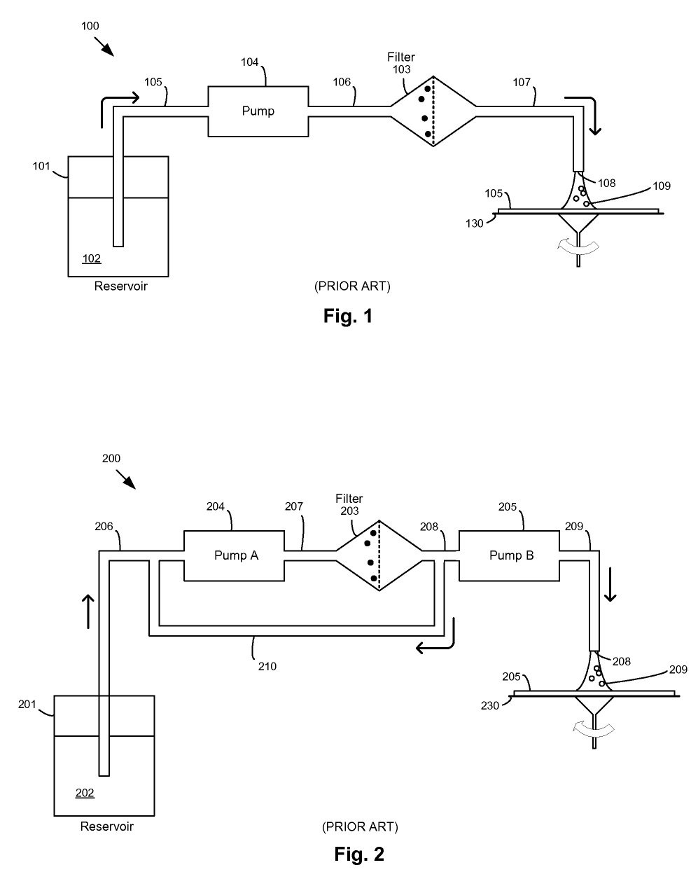

### DETAILED DESCRIPTION OF ILLUSTRATIVE EMBODIMENTS

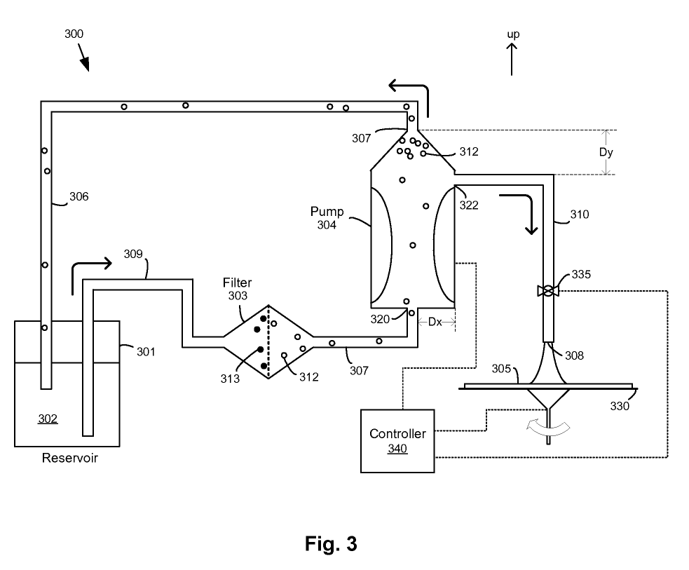

FIG. 3 is a functional block diagram of an illustrative pumping/dispensing system 300 that effectively reduces or even completely removes bubbles from a solution prior to dispensing the solution. FIG. 3 is merely illustrative of the various embodiments and alternatives described herein.

System 300 includes or is coupled to a reservoir 301, which contains a solution 302 such as resist or ARC. Various conduits, which allow for solution 302 to flow from one location to another, are arranged as follows in the present example. The direction of solution flow is indicated in FIG. 3 for various conduits with solid arrows adjacent to those conduits. In accordance with FIG. 3, a conduit 309 provides a solution flow path between reservoir 301 and an input of a filter 303. A conduit 307 provides a solution flow path between an output of filter 303 and an input 320 of a pump 304. Pump 304 also has a first output for providing expelled solution to a conduit 306, which provides a solution flow path back to reservoir 302. Pump 304 further has a second output for providing expelled solution to a conduit 310, which provides a solution flow path to an outlet 308 through a valve 335. Solution 302 is then expelled from outlet 308 to a semiconductor wafer 305, which may be on a platform 330 that is spinning at the time that solution 302 is applied to semiconductor wafer 305, thereby causing semiconductor wafer 305 to also spin. Such spinning allows solution 302 to spread more evenly across semiconductor wafer 305. A controller 340 may coordinate and control the operation of system 100, including the pumping of pump 304, the spinning of platform 330, and/or the state of valve 335.

Thus, solution 302 may follow either a feedback loop provided by conduits 309, 307, and 306, or a forward path provided by conduits 309, 307, and 310. As will be discussed further below, the feedback path collects bubbles from solution 302 while the forward path sends solution 302 having no bubbles (or at least fewer bubbles) for applying to semiconductor wafer 305. By allowing the relatively bubble-dense solution 302 to flow back to reservoir 302 via conduit 306, that solution 302 may be re-used after it is mixed with the existing solution 302 in reservoir 302. This is extremely desirable where solution 302 is expensive and reusable. For example, resist that has not been contaminated is reusable, and costs hundreds, if not thousands, of dollars per gallon. Moreover, system 300 is able to re-circulate solution 302 with only a single pump. Thus system 300 does not waste solution 302 and is also more efficient than dual-stage systems.

Although only a single reservoir 302 is shown, multiple reservoirs may be provided, each containing a different solution. For instance, reservoir 301 may contain resist solution and a second reservoir (not shown) may contain ARC solution. In such a case, each reservoir may be associated with its own parallel solution dispensing apparatus configured such as in FIG. 3. Reservoir 301 may be any type of reservoir that is capable of holding a quantity of solution 302. For example, reservoir 301 may be a cup-shaped or jug-shaped container. Reservoir 301 may be open or closed at the top. Where closed, relatively small openings may be provided through which conduits 306 and 309 may pass into reservoir 301. As shown, the output end of conduit 306 is disposed below the fluid level of solution 302 in reservoir 301. Although this is not necessary, such a configuration may reduce splashing and thus reduce adding to the amount of dissolved gas and/or bubbles that may already be in solution 302 contained in reservoir 301.

Filter 303 filters out solid contaminants (indicated in FIG. 3 as black circles) from solution 302 and outputs filtered solution 302 to conduit 307. Because input 320 of pump 304 is disposed after the output of filter 303, conduit 307 is at the lowest pressure in entire system 300, and is even lower than the ambient air pressure outside of system 300. The sudden pressure drop across filter 303 is large enough to induce generation of bubbles 312 from the gas already dissolved in solution 302. Thus, bubble-containing solution 302 is fed into input 230 of pump 304.

Pump 304 is configured to expel a portion of solution 302 that contains bubbles 312 upward to output 307 and the remainder of solution 302 that does not contain bubbles 312 (or that contains less bubbles) to output 322. To allow for this to occur, in this particular embodiment the main chamber of pump 304 is vertically arranged such that output 322 is lower than output 307 by a distance Dy and laterally displaced from input 307 by a distance Dx. In addition, as shown, output 307 is vertically aligned with input 320. Because bubbles 312 will naturally rise upward in solution 302 due to their buoyancy, the particular configuration of pump 304 may cause most if not all of bubbles 312 to have gained sufficient vertical momentum by the time they reach lower output 322 to not be expelled out of output 322. Instead, most is not all of bubbles 312 will continue upward and be expelled out of output 307.

Distances Dx and Dy may be chosen appropriately based upon the size of the chamber of pump 304, the flow rate of solution 302 through pump 304, and the viscosity of solution 302. For example, where solution 302 is a resist solution, Dx may be approximately 15 mm and Dy may be approximately 20 mm. As another example, where solution 302 is an ARC solution, Dx may be approximately 10 mm and Dy may be approximately 15 mm.

Many variations of pump 304 are within the scope of the present disclosure. For example, although output 307 is shown as disposed on a ceiling of pump 304 and output 322 is shown disposed on a sidewall of pump 304, either of these outputs may be on a ceiling or a sidewall. Also, instead of or in addition to using the different vertical heights of outputs 307 and 322 to separate bubbles 312, one or more baffles within pump 304, or other arrangements within or of pump 304, may be used to separate bubbles 312 away from output 322.

In operation, semiconductor wafer 305 is placed on platform 330. At this time, pump 304 may already be pumping solution 302 through the feedback path of conduit 306. However, at this time valve 335 may be in a closed state such that no solution 302 is allowed to pass to outlet 308. Valves such as valve 335 are well known in the art. Next, controller 340 may control platform 330 to begin spinning at a predetermined rotation speed, thereby also spinning semiconductor wafer 305 along with platform 330. While platform 330 is spinning, controller 340 may cause valve 335 to open for a predetermined length of time and by a predetermined amount, thereby causing solution 312 (with reduced or no bubbles) to pour onto semiconductor wafer 305. After valve 335 is closed, controller 340 may control platform 330 to stop spinning. Alternatively, controller 340 may thereafter cause a second and parallel set of pumps and valves (not shown) to cause a second solution to pour onto semiconductor wafer 305, over the first poured solution 302. In this example, solution 302 may be a resist solution and the second solution may be an ARC solution. A third solution, such as a solvent, may also be poured onto semiconductor wafer 305 prior to the resist solution being poured. After all of the desired solutions have been applied to semiconductor wafer 305, then semiconductor wafer 305 is removed from platform 330 and undergoes the next step in the manufacturing process. Often, the next step includes lithography.

In some embodiments, pump 304 is operated continuously, regardless of the state of valve 335. In other embodiments, pump 304 is operated intermittently, either independently of the state of valve 335 or with some dependence on the state of valve 335. Intermittent operation of pump 304 may increase the effectiveness of its bubble-separating capabilities. For instance, by turning pump 304 on and off periodically, bubbles 312 may be given more time to rise to toward the top of the chamber of pump 304 while the pumping action is off, before the pumping action is turned on again, thus increasing the proportion of bubbles that are expelled from output 307 as compared with output 322.

Thus, improved illustrative apparatuses and methods of pumping solution, such as resist and ARC solutions, has been described.

What is claimed is:

1. An apparatus for pumping a solution, comprising:
a reservoir configured to hold the solution;
a pump having an input, a first output, and a second output separate from the first output and disposed vertically lower than the first output;
a first solution flow path between the reservoir and the input of the pump; and
a second solution flow path between the first output of the pump and the reservoir,
wherein the pump is configured to pump the solution from the first solution flow path into the first input and to expel a portion of the pumped solution to the first output and a remainder of the pumped solution to the second output, and wherein the pump is further configured such that bubbles in the pumped solution rise upward from the input to the first output above the second output.

2. The apparatus of claim 1, wherein the second output of the pump is horizontally displaced from the input of the pump.

3. The apparatus of claim 1, further including:
a third solution flow path between the second output and an opening out of which solution flows;
a platform disposed underneath the open end, wherein the platform is configured to spin; and
a controller configured to control the platform such that the platform spins while the solution flows out of the opening.

4. The apparatus of claim 3, further including:
a valve disposed in the third solution flow path and configured to allow, in an open state, a flow of the solution through the third solution path, and to block, in a closed stated, a flow of the solution through the third solution flow path,
wherein the controller is further configured to control the pump to operate while the valve is in both the closed state and the open state.

5. The apparatus of claim 1, wherein the apparatus further includes a filter disposed in the first solution flow path, wherein a lowest pressure of the solution in the apparatus is at a location in the first solution flow path between the filter and the input of the pump.

6. The apparatus of claim 5, wherein the bubbles are created by the solution passing through the filter.

7. An apparatus for pumping a solution, comprising:
a reservoir configured to hold the solution;
a pump having an input, a first output, and a second output separate from the first output;
a first solution flow path between the reservoir and the input of the pump;
a filter disposed in the first solution flow path such that the solution that flows through the first solution flow path flows through the filter, wherein a pressure drop of the solution occurs across the filter, and wherein a pressure of the solution in the first solution flow path between the filter and the input of the pump is lower than a pressure of the solution at any other location in the apparatus; and
a second solution flow path between the first output of the pump and the reservoir,
wherein the pump is configured to pump the solution from the first solution flow path into the first input and to expel a portion of the pumped solution to the first output and a remainder of the pumped solution to the second output.

8. The apparatus of claim 7, wherein the first output of the pump is vertically aligned with the input of the pump and the second output of the pump is horizontally displaced from the input of the pump.

9. The apparatus of claim 8, wherein the second output of the pump is disposed vertically lower than the first output of the pump.

10. The apparatus of claim 7, further including:
a third solution flow path between the second output and an opening out of which solution flows;
a platform disposed underneath the open end, wherein the platform is configured to spin; and
a controller configured to control the platform such that the platform spins while the solution flows out of the opening.

11. The apparatus of claim 10, further including:
a valve disposed in the third solution flow path and configured to allow, in an open state, a flow of the solution through the third solution flow path, and to block, in a closed stated, a flow of the solution through the third solution flow path.
wherein the controller is further configured to control the pump to operate while the valve is in both the closed state and the open state.

12. The apparatus of claim 7, wherein bubbles are created by the solution passing through the filter.

13. An apparatus for pumping a solution, comprising:
a reservoir for holding the solution;
first solution flow path means for providing the solution from the reservoir;
filtering means for filtering the solution provided from the first solution flow path means;
second solution flow path means for providing a first portion of the solution back to the reservoir;
pumping means for pumping the solution received from the filtering means and for directing bubbles in the solution toward the second solution flow path means such that the bubbles are included in the first portion of the solution that flows back to the reservoir; and
third solution flow path means for providing a second portion of the solution from the pumping means to a location other than the reservoir.

14. The apparatus of claim 13, further including:
a platform disposed at the location, wherein the platform is configured to spin; and
a controller configured to control the platform such that the platform spins while the solution flows to the location.

15. The apparatus of claim 14, further including:
a valve disposed in the third solution flow path means and configured to allow, in an open state, a flow of the solution along the third solution path means, and to block, in a closed stated, a flow of the solution along the third solution flow path means,
wherein the controller is further configured to control the pump to operate while the valve is in both the closed state and the open state.

16. The apparatus of claim 13, wherein a lowest pressure of the solution in the apparatus is at a location along the first solution flow path means between the filtering means and the pumping means.

17. The apparatus of claim 13, wherein the bubbles are created by the solution passing through the filtering means.
